(19) United States
(12) Patent Application Publication
(10) Pub. No.: US 2024/0004690 A1
(43) Pub. Date: Jan. 4, 2024

(54) BUILDING MANAGEMENT SYSTEM WITH SEMICONDUCTOR FARM AND VIRTUALIZED FIELD CONTROLLERS

(71) Applicant: Johnson Controls Tyco IP Holdings LLP, Milwaukee, WI (US)

(72) Inventors: Prasanna Manohar Bari, Pune (IN); Mangesh Maruti Edake, Pune (IN); Ramesh Shiva Satya Bhupathiraju, Secunderabad (IN); Tousif Hanif Khan, Pune (IN); Padmanabh Pandurang Gawai, Pune (IN); Balakrishnan Arumugam, Pune (IN)

(21) Appl. No.: 18/215,990

(22) Filed: Jun. 29, 2023

(30) Foreign Application Priority Data
Jun. 30, 2022 (IN) 20221037615

(51) Int. Cl. G06F 9/455

(52) U.S. Cl. CPC G06F 9/45558; G06F 2009/4557

(57) ABSTRACT

A system including a semiconductor farm programmed to provide virtualized controllers. The system also includes input/output hardware units corresponding to the plurality of virtualized controller. The plurality of virtualized controllers control building equipment via the plurality of input/output devices.

### CROSS-REFERENCE TO RELATED APPLICATION

This application claims priority to and the benefit of Indian Application No. 20221037615 filed Jun. 30, 2022, the entire disclosure of which is incorporated by reference herein in its entirety.

### BACKGROUND

The present disclosure relates generally to a building management system (BMS). A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof. In some scenarios, a BMS is associated with a source of green energy, such as a photovoltaic energy system, that provides energy to other equipment and devices associated with the BMS.

### SUMMARY

An implementation of the present disclosure is a system. The system includes a semiconductor farm programmed to provide a plurality of virtualized controllers and a plurality of input/output hardware units corresponding to the plurality of virtualized controller. The plurality of virtualized controllers control building equipment via the plurality of input/output devices. The plurality of input/output hardware units are configured to communicate with the semiconductor farm via first communications modality and a second communications modality, and the input/output hardware units communicate with the semiconductor farm via the second communications modality responsive to interruption of the first communications modality.

In some embodiments, the semiconductor farm is programmed to provide the plurality of virtualized controllers in a plurality of scalable containers. The semiconductor farm may be further configured to automatically adjust allocations of processing power and/or memory to the plurality of virtualized controllers based on demands of the plurality of virtualized controllers.

In some embodiments, the semiconductor farm includes a first type of chip and a second type of chip. The semiconductor farm may be configured to provide the first virtual controller using the first type of chip and provide the second virtualized controller using the second type of chip based on different functions to be provided by the first virtualized controller and the second virtualized controller. The second type of chip may be configured for artificial intelligence processing and the second virtualized controller is configured to provide an artificial intelligence function. The semiconductor farm can reallocate, responsive to selection of an artificial intelligence function for the first virtualized controller, one or more chips of the second type of chip to the first virtualized controller.

In some embodiments, the plurality input/output hardware units are configured to control the building equipment in a fail-safe routine in response to a loss of communications in both the first communications modality and the second communications modality between the plurality of input/output modules and the semiconductor farm. The building equipment can include a plurality of sensors and actuators corresponding to the plurality of input/output hardware units and the plurality of virtualized controllers.

Another implementation of the present disclosure is a method. The method includes providing, via a semiconductor farm, a plurality of virtual controllers, automatically allocating different types of processing hardware or memory hardware of the semiconductor farm across the plurality of virtual controllers such that different controllers of the plurality of virtual controllers are provided with different types of processing hardware or memory hardware, and controlling, via an edge device coupled to building equipment, the building equipment using the plurality of virtual controllers.

In some embodiments, the method includes allocating the different types of memory hardware based on different memory bandwidth requirements of the plurality of different controllers. In some embodiments, the plurality of different types of processing hardware includes artificial-intelligence-adapted chips and the method includes allocating the artificial-intelligence-adapted chips to a first subset of the plurality of virtual controllers and not to a second subset of the plurality of virtual controllers. In some embodiments, the method includes determining the first subset as controllers of the plurality of virtual controllers for which at least one artificial intelligence function is selected.

In some embodiments, the method includes communicating between the semiconductor farm and the edge device via a primary communications channel, communicating, responsive to an interruption of the primary communications, between the semiconductor farm and the edge device via a back-up communications channel. The primary communications channel can include a building automation network and the back-up communications channel can include a cellular network. In some embodiments, the method includes controlling, by the edge device, the building equipment in a fail-safe routine responsive to interruption of both the primary communications channel and the back-up communications channel. In some embodiments, providing, via the semiconductor farm, the plurality of virtual controllers includes providing a plurality of scalable containers.

Another implementation of the present disclosure is a field controller for building equipment. The field controller includes a communications interface configured to provide communications between building equipment and a semiconductor farm via a plurality of communications modalities and a virtualized control engine executing control logic at the semiconductor farm. The field controller is configured to control the building equipment to affect a variable state or condition of a building by executing the control logic.

In some embodiments, the communications interface is further configured to provide communications between a sensor measuring the variable state or condition of the building and the semiconductor farm. The communications interface may communicate with the semiconductor farm via both a wired channel of the plurality of communications modalities and a wireless channel of the plurality of communications modalities. The wired channel may be independent of the wireless channel. In some embodiments, the virtualized control engine is configured to be selectively provided using artificial-intelligence-adapted hardware of the semiconductor farm responsive to selection of an artificial intelligence feature for the virtualized control engine.

### BRIEF DESCRIPTION OF THE DRAWINGS

Various aspects and advantages of systems and methods will become apparent to those skilled in the art from the following detailed description of the embodiments. Embodiments will be described with reference to the accompanying drawings, wherein like reference numerals indicate like elements, and:

FIG. 1 is a drawing of a building equipped with a HVAC system, according to some embodiments.

FIG. 2 is a block diagram of a waterside system which can be used to serve the building of FIG. 1, according to some embodiments.

FIG. 3 is a block diagram of an airside system which can be used to serve the building of FIG. 1, according to some embodiments.

FIG. 4 is a block diagram of a building management system (BMS) which can be used to monitor and control the building of FIG. 1, according to some embodiments.

FIG. 5 is a block diagram of another BMS which can be used to monitor and control the building of FIG. 1, according to some embodiments.

FIG. 6 is a block diagram of a field controller, according to some embodiments.

FIG. 7 is a block diagram a system including field controllers and a semiconductor farm, according to some embodiments.

FIG. 8 is another block diagram of the system of FIG. 7, according to some embodiments.

FIG. 9 is another block diagram of the system of FIG. 7, according to some embodiments.

FIG. 10 is a another block diagram of the system of FIG. 7, according to some embodiments.

FIG. 11 is a flowchart of a commissioning workflow for the system of FIG. 7, according to some embodiments.

### DETAILED DESCRIPTION

### Overview

Referring generally to the figures, systems and methods relating to building management systems with virtualized field controllers are shown, according to some embodiments. Some embodiments herein relate to virtualization of field controllers by cultivating modular and scalable semiconductor farms.

Many building management systems include field controllers installed through buildings, facilities, etc. Field controllers may be designed and built based on current system requirements, and thus may become obsolete as innovation occurs in other aspects of a building management system. To upgrade an installed base of field controllers or other devices as system requirements evolve, new field controllers may need to be manufactured, purchased, and installed at a building, which may be a slow and expensive process and can frustrate owners of field controllers who may expect a longer life cycle for controllers. Aspects of the present application relate to addressing such challenges by virtualization of field controllers in a manner that allows updates to processing and memory capabilities for field controllers as requirements and demands evolve without installation of new hardware at a building. Features herein allow for faster updates, low cost updates, extended lifecycle of installed devices, reduced reliance on manufacturing and supply chain, reduce maintenance tasks and improved service offerings, etc., in various embodiments. Other advantages will be made apparent from the following description and including appropriate and dynamic scaling of memory and processing power needs, redundancy within semiconductor farms hosting virtualized control processes, and easy migration of data between storage tiers, pairing advantages of virtualized systems with the embedded buildings hardware as described herein.

### Building HVAC Systems and Building Management Systems

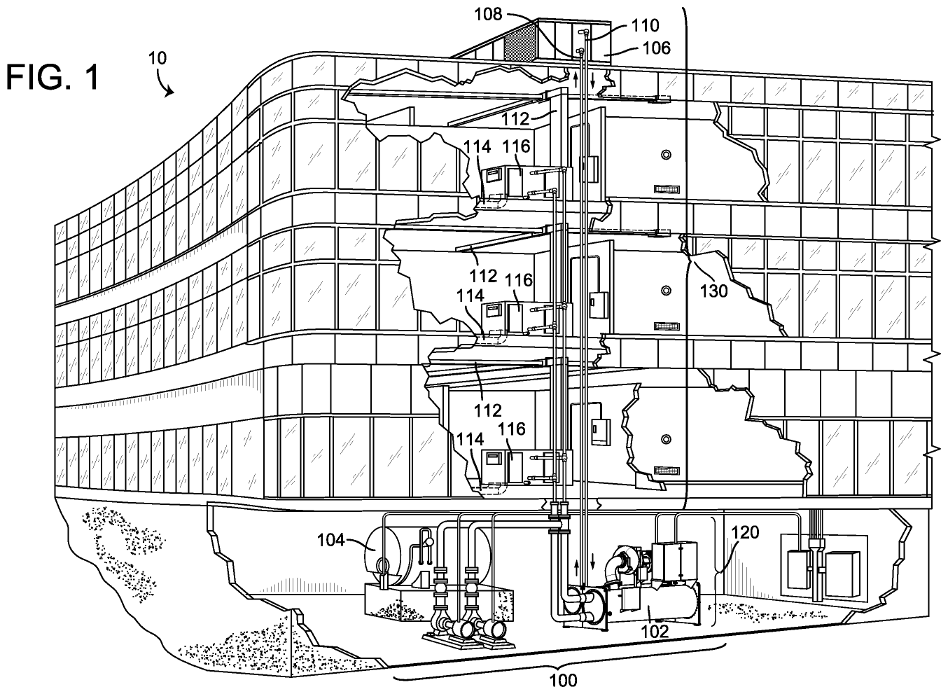

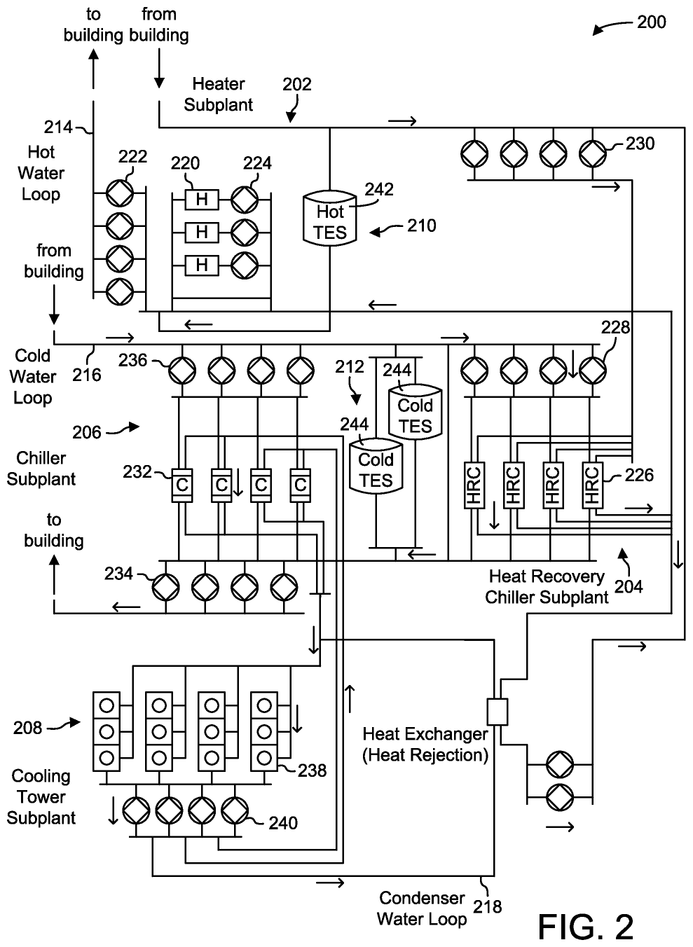

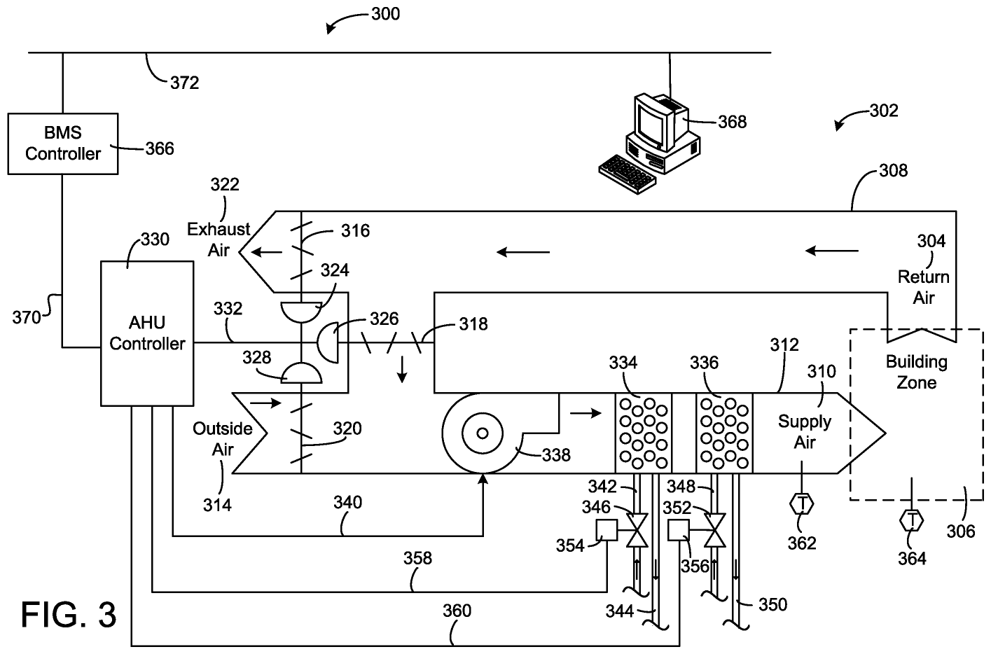

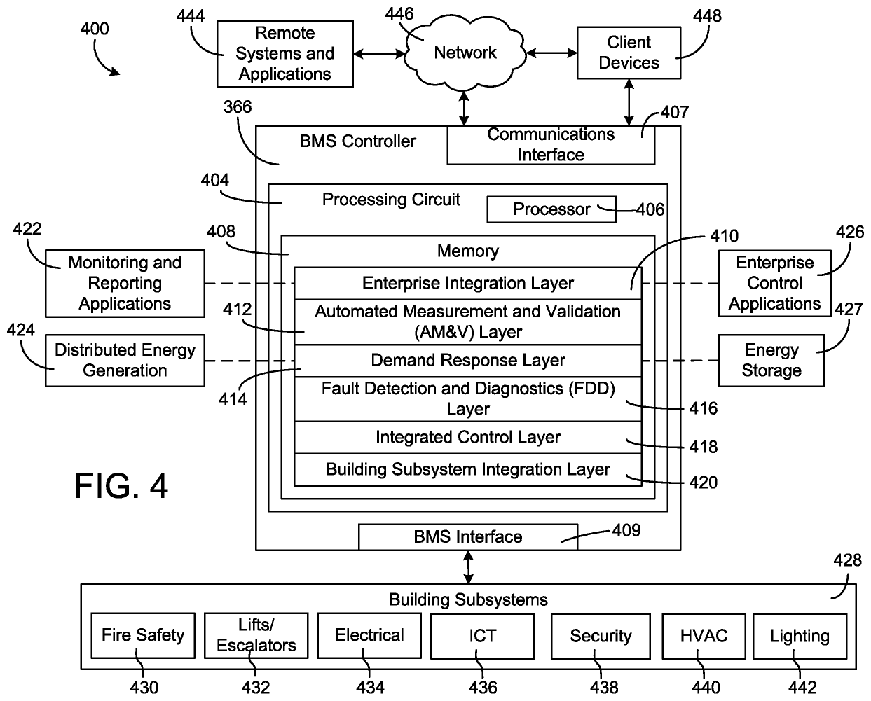

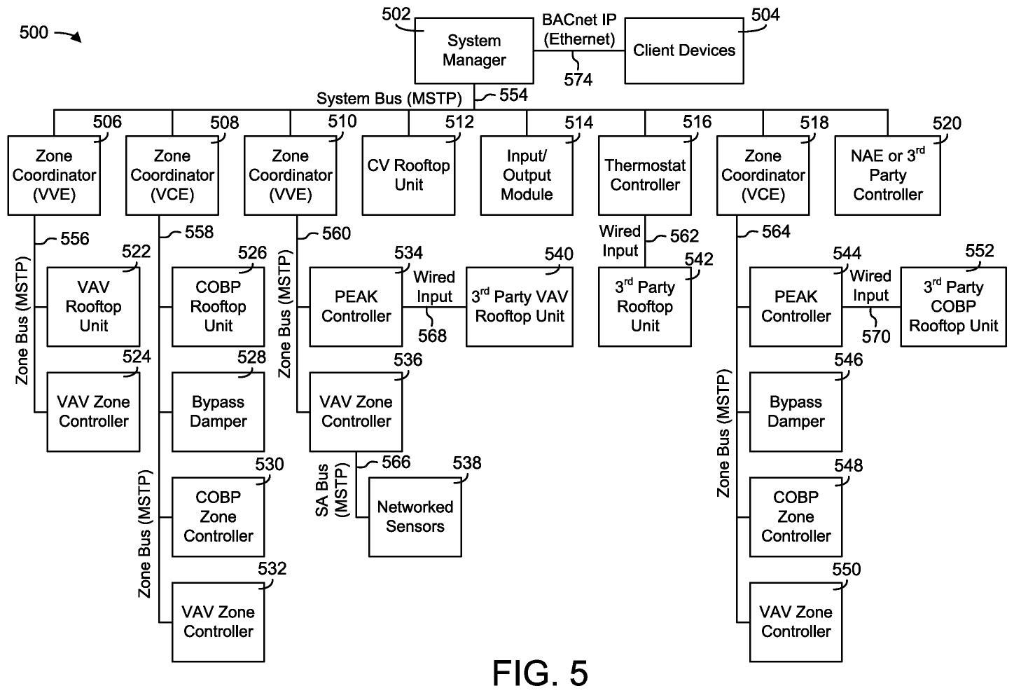

Referring now to FIGS. 1-5, several building management systems (BMS) and HVAC systems in which the systems and methods of the present disclosure can be implemented are shown, according to some embodiments. In brief overview, FIG. 1 shows a building 10 equipped with a HVAC system 100. FIG. 2 is a block diagram of a waterside system 200 which can be used to serve building 10. FIG. 3 is a block diagram of an airside system 300 which can be used to serve building 10. FIG. 4 is a block diagram of a BMS which can be used to monitor and control building 10. FIG. 5 is a block diagram of another BMS which can be used to monitor and control building 10.

### Building and HVAC System

Referring particularly to FIG. 1, a perspective view of a building 10 is shown. Building 10 is served by a BMS. A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof.

The BMS that serves building 10 includes a HVAC system 100. HVAC system 100 can include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 may provide a heated or chilled fluid to an air handling unit of airside system 130. Airside system 130 may use the heated or chilled fluid to heat or cool an airflow provided to building 10. An exemplary waterside system and airside system which can be used in HVAC system 100 are described in greater detail with reference to FIGS. 2-3.

HVAC system 100 is shown to include a chiller 102, a boiler 104, and a rooftop air handling unit (AHU) 106. Waterside system 120 may use boiler 104 and chiller 102 to heat or cool a working fluid (e.g., water, glycol, etc.) and may circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 may add heat to the circulated fluid, for example, by burning a combustible material (e.g., natural gas) or using an electric heating element. Chiller 102 may place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 may place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 may transfer heat between the airflow and the working fluid to provide heating or cooling for the airflow. For example, AHU 106 can include one or more fans or blowers configured to pass the airflow over or through a heat exchanger containing the working fluid. The working fluid may then return to chiller 102 or boiler 104 via piping 110.

Airside system 130 may deliver the airflow supplied by AHU 106 (i.e., the supply airflow) to building 10 via air supply ducts 112 and may provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 may receive input from sensors located within AHU 106 and/or within the building zone and may adjust the flow rate, temperature, or other attributes of the supply airflow through AHU 106 to achieve setpoint conditions for the building zone.

### Waterside System

Referring now to FIG. 2, a block diagram of a waterside system 200 is shown, according to some embodiments. In various embodiments, waterside system 200 may supplement or replace waterside system 120 in HVAC system 100 or can be implemented separate from HVAC system 100. When implemented in HVAC system 100, waterside system 200 can include a subset of the HVAC devices in HVAC system 100 (e.g., boiler 104, chiller 102, pumps, valves, etc.) and may operate to supply a heated or chilled fluid to AHU 106. The HVAC devices of waterside system 200 can be located within building 10 (e.g., as components of waterside system 120) or at an offsite location such as a central plant.

In FIG. 2, waterside system 200 is shown as a central plant having a plurality of subplants 202-212. Subplants 202-212 are shown to include a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources (e.g., water, natural gas, electricity, etc.) from utilities to serve thermal energy loads (e.g., hot water, cold water, heating, cooling, etc.) of a building or campus. For example, heater subplant 202 can be configured to heat water in a hot water loop 214 that circulates the hot water between heater subplant 202 and building 10. Chiller subplant 206 can be configured to chill water in a cold water loop 216 that circulates the cold water between chiller subplant 206 building 10. Heat recovery chiller subplant 204 can be configured to transfer heat from cold water loop 216 to hot water loop 214 to provide additional heating for the hot water and additional cooling for the cold water. Condenser water loop 218 may absorb heat from the cold water in chiller subplant 206 and reject the absorbed heat in cooling tower subplant 208 or transfer the absorbed heat to hot water loop 214. Hot TES subplant 210 and cold TES subplant 212 may store hot and cold thermal energy, respectively, for subsequent use.

Hot water loop 214 and cold water loop 216 may deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air can be delivered to individual zones of building 10 to serve thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO2, etc.) can be used in place of or in addition to water to serve thermal energy loads. In other embodiments, subplants 202-212 may provide heating and/or cooling directly to the building or campus without requiring an intermediate heat transfer fluid. These and other variations to waterside system 200 are within the teachings of the present disclosure.

Each of subplants 202-212 can include a variety of equipment configured to facilitate the functions of the subplant. For example, heater subplant 202 is shown to include a plurality of heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include a plurality of chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include a plurality of heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include a plurality of cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

Hot TES subplant 210 is shown to include a hot TES tank 242 configured to store the hot water for later use. Hot TES subplant 210 may also include one or more pumps or valves configured to control the flow rate of the hot water into or out of hot TES tank 242. Cold TES subplant 212 is shown to include cold TES tanks 244 configured to store the cold water for later use. Cold TES subplant 212 may also include one or more pumps or valves configured to control the flow rate of the cold water into or out of cold TES tanks 244.

In some embodiments, one or more of the pumps in waterside system 200 (e.g., pumps 222, 224, 228, 230, 234, 236, and/or 240) or pipelines in waterside system 200 include an isolation valve associated therewith. Isolation valves can be integrated with the pumps or positioned upstream or downstream of the pumps to control the fluid flows in waterside system 200. In various embodiments, waterside system 200 can include more, fewer, or different types of devices and/or subplants based on the particular configuration of waterside system 200 and the types of loads served by waterside system 200.

### Airside System

Referring now to FIG. 3, a block diagram of an airside system 300 is shown, according to some embodiments. In various embodiments, airside system 300 may supplement or replace airside system 130 in HVAC system 100 or can be implemented separate from HVAC system 100. When implemented in HVAC system 100, airside system 300 can include a subset of the HVAC devices in HVAC system 100 (e.g., AHU 106, VAV units 116, ducts 112-114, fans, dampers, etc.) and can be located in or around building 10. Airside system 300 may operate to heat or cool an airflow provided to building 10 using a heated or chilled fluid provided by waterside system 200.

In FIG. 3, airside system 300 is shown to include an economizer-type air handling unit (AHU) 302. Economizer-type AHUs vary the amount of outside air and return air used by the air handling unit for heating or cooling. For example, AHU 302 may receive return air 304 from building zone 306 via return air duct 308 and may deliver supply air 310 to building zone 306 via supply air duct 312. In some embodiments, AHU 302 is a rooftop unit located on the roof of building 10 (e.g., AHU 106 as shown in FIG. 1) or otherwise positioned to receive both return air 304 and outside air 314. AHU 302 can be configured to operate exhaust air damper 316, mixing damper 318, and outside air damper 320 to control an amount of outside air 314 and return air 304 that combine to form supply air 310. Any return air 304 that does not pass through mixing damper 318 can be exhausted from AHU 302 through exhaust damper 316 as exhaust air 322.

Each of dampers 316-320 can be operated by an actuator. For example, exhaust air damper 316 can be operated by actuator 324, mixing damper 318 can be operated by actuator 326, and outside air damper 320 can be operated by actuator 328. Actuators 324-328 may communicate with an AHU controller 330 via a communications link 332. Actuators 324-328 may receive control signals from AHU controller 330 and may provide feedback signals to AHU controller 330. Feedback signals can include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that can be collected, stored, or used by actuators 324-328. AHU controller 330 can be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328.

Still referring to FIG. 3, AHU 302 is shown to include a cooling coil 334, a heating coil 336, and a fan 338 positioned within supply air duct 312. Fan 338 can be configured to force supply air 310 through cooling coil 334 and/or heating coil 336 and provide supply air 310 to building zone 306. AHU controller 330 may communicate with fan 338 via communications link 340 to control a flow rate of supply air 310. In some embodiments, AHU controller 330 controls an amount of heating or cooling applied to supply air 310 by modulating a speed of fan 338.

Cooling coil 334 may receive a chilled fluid from waterside system 200 (e.g., from cold water loop 216) via piping 342 and may return the chilled fluid to waterside system 200 via piping 344. Valve 346 can be positioned along piping 342 or piping 344 to control a flow rate of the chilled fluid through cooling coil 334. In some embodiments, cooling coil 334 includes multiple stages of cooling coils that can be independently activated and deactivated (e.g., by AHU controller 330, by BMS controller 366, etc.) to modulate an amount of cooling applied to supply air 310.

Heating coil 336 may receive a heated fluid from waterside system 200 (e.g., from hot water loop 214) via piping 348 and may return the heated fluid to waterside system 200 via piping 350. Valve 352 can be positioned along piping 348 or piping 350 to control a flow rate of the heated fluid through heating coil 336. In some embodiments, heating coil 336 includes multiple stages of heating coils that can be independently activated and deactivated (e.g., by AHU controller 330, by BMS controller 366, etc.) to modulate an amount of heating applied to supply air 310.

Each of valves 346 and 352 can be controlled by an actuator. For example, valve 346 can be controlled by actuator 354 and valve 352 can be controlled by actuator 356. Actuators 354-356 may communicate with AHU controller 330 via communications links 358-360. Actuators 354-356 may receive control signals from AHU controller 330 and may provide feedback signals to controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 may also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a setpoint temperature for supply air 310 or to maintain the temperature of supply air 310 within a setpoint temperature range). The positions of valves 346 and 352 affect the amount of heating or cooling provided to supply air 310 by cooling coil 334 or heating coil 336 and may correlate with the amount of energy consumed to achieve a desired supply air temperature. AHU 330 may control the temperature of supply air 310 and/or building zone 306 by activating or deactivating coils 334-336, adjusting a speed of fan 338, or a combination of both.

Still referring to FIG. 3, airside system 300 is shown to include a building management system (BMS) controller 366 and a client device 368. BMS controller 366 can include one or more computer systems (e.g., servers, supervisory controllers, subsystem controllers, etc.) that serve as system level controllers, application or data servers, head nodes, or master controllers for airside system 300, waterside system 200, HVAC system 100, and/or other controllable systems that serve building 10. BMS controller 366 may communicate with multiple downstream building systems or subsystems (e.g., HVAC system 100, a security system, a lighting system, waterside system 200, etc.) via a communications link 370 according to like or disparate protocols (e.g., LON, BACnet, etc.). In various embodiments, AHU controller 330 and BMS controller 366 can be separate (as shown in FIG. 3) or integrated. In an integrated implementation, AHU controller 330 can be a software module configured for execution by a processor of BMS controller 366.

In some embodiments, AHU controller 330 receives information from BMS controller 366 (e.g., commands, setpoints, operating boundaries, etc.) and provides information to BMS controller 366 (e.g., temperature measurements, valve or actuator positions, operating statuses, diagnostics, etc.). For example, AHU controller 330 may provide BMS controller 366 with temperature measurements from temperature sensors 362-364, equipment on/off states, equipment operating capacities, and/or any other information that can be used by BMS controller 366 to monitor or control a variable state or condition within building zone 306.

Client device 368 can include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 368 can be a computer workstation, a client terminal, a remote or local interface, or any other type of user interface device. Client device 368 can be a stationary terminal or a mobile device. For example, client device 368 can be a desktop computer, a computer server with a user interface, a laptop computer, a tablet, a smartphone, a PDA, or any other type of mobile or non-mobile device. Client device 368 may communicate with BMS controller 366 and/or AHU controller 330 via communications link 372.

### Building Management Systems

Referring now to FIG. 4, a block diagram of a building management system (BMS) 400 is shown, according to some embodiments. BMS 400 can be implemented in building 10 to automatically monitor and control various building functions. BMS 400 is shown to include BMS controller 366 and a plurality of building subsystems 428. Building subsystems 428 are shown to include a building electrical subsystem 434, an information communication technology (ICT) subsystem 436, a security subsystem 438, a HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 may also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 428 include waterside system 200 and/or airside system 300, as described with reference to FIGS. 2-3.

Each of building subsystems 428 can include any number of devices, controllers, and connections for completing its individual functions and control activities. HVAC subsystem 440 can include many of the same components as HVAC system 100, as described with reference to FIGS. 1-3. For example, HVAC subsystem 440 can include a chiller, a boiler, any number of air handling units, economizers, field controllers, supervisory controllers, actuators, temperature sensors, and other devices for controlling the temperature, humidity, airflow, or other variable conditions within building 10. Lighting subsystem 442 can include any number of light fixtures, ballasts, lighting sensors, dimmers, or other devices configured to controllably adjust the amount of light provided to a building space. Security subsystem 438 can include occupancy sensors, video surveillance cameras, digital video recorders, video processing servers, intrusion detection devices, access control devices and servers, or other security-related devices.

Still referring to FIG. 4, BMS controller 366 is shown to include a communications interface 407 and a BMS interface 409. Interface 407 may facilitate communications between BMS controller 366 and external applications (e.g., monitoring and reporting applications 422, enterprise control applications 426, remote systems and applications 444, applications residing on client devices 448, etc.) for allowing user control, monitoring, and adjustment to BMS controller 366 and/or subsystems 428. Interface 407 may also facilitate communications between BMS controller 366 and client devices 448. BMS interface 409 may facilitate communications between BMS controller 366 and building subsystems 428 (e.g., HVAC, lighting security, lifts, power distribution, business, etc.).

Interfaces 407, 409 can be or include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407, 409 can be direct (e.g., local wired or wireless communications) or via a communications network 446 (e.g., a WAN, the Internet, a cellular network, etc.). For example, interfaces 407, 409 can include an Ethernet card and port for sending and receiving data via an Ethernet-based communications link or network. In another example, interfaces 407, 409 can include a Wi-Fi transceiver for communicating via a wireless communications network. In another example, one or both of interfaces 407, 409 can include cellular or mobile phone communications transceivers. In one embodiment, communications interface 407 is a power line communications interface and BMS interface 409 is an Ethernet interface. In other embodiments, both communications interface 407 and BMS interface 409 are Ethernet interfaces or are the same Ethernet interface.

Still referring to FIG. 4, BMS controller 366 is shown to include a processing circuit 404 including a processor 406 and memory 408. Processing circuit 404 can be communicably connected to BMS interface 409 and/or communications interface 407 such that processing circuit 404 and the various components thereof can send and receive data via interfaces 407, 409. Processor 406 can be implemented as a general purpose processor, an application specific integrated circuit (ASIC), one or more field programmable gate arrays (FPGAs), a group of processing components, or other suitable electronic processing components.

Memory 408 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 408 can be or include volatile memory or non-volatile memory. Memory 408 can include database components, object code components, script components, or any other type of information structure for supporting the various activities and information structures described in the present application. According to some embodiments, memory 408 is communicably connected to processor 406 via processing circuit 404 and includes computer code for executing (e.g., by processing circuit 404 and/or processor 406) one or more processes described herein. One or more non-transitory computer readable media can store instructions that when executed by one or more processors perform the operations disclosed herein.

In some embodiments, BMS controller 366 is implemented within a single computer (e.g., one server, one housing, etc.). In various other embodiments BMS controller 366 can be distributed across multiple servers or computers (e.g., that can exist in distributed locations). Further, while FIG. 4 shows applications 422 and 426 as existing outside of BMS controller 366, in some embodiments, applications 422 and 426 can be hosted within BMS controller 366 (e.g., within memory 408).

Still referring to FIG. 4, memory 408 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 can be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BMS 400.

Enterprise integration layer 410 can be configured to serve clients or local applications with information and services to support a variety of enterprise-level applications. For example, enterprise control applications 426 can be configured to provide subsystem-spanning control to a graphical user interface (GUI) or to any number of enterprise-level business applications (e.g., accounting systems, user identification systems, etc.). Enterprise control applications 426 may also or alternatively be configured to provide configuration GUIs for configuring BMS controller 366. In yet other embodiments, enterprise control applications 426 can work with layers 410-420 to optimize building performance (e.g., efficiency, energy use, comfort, or safety) based on inputs received at interface 407 and/or BMS interface 409.

Building subsystem integration layer 420 can be configured to manage communications between BMS controller 366 and building subsystems 428. For example, building subsystem integration layer 420 may receive sensor data and input signals from building subsystems 428 and provide output data and control signals to building subsystems 428. Building subsystem integration layer 420 may also be configured to manage communications between building subsystems 428. Building subsystem integration layer 420 translate communications (e.g., sensor data, input signals, output signals, etc.) across a plurality of multi-vendor/multi-protocol systems.

Demand response layer 414 can be configured to optimize resource usage (e.g., electricity use, natural gas use, water use, etc.) and/or the monetary cost of such resource usage in response to satisfy the demand of building 10. The optimization can be based on time-of-use prices, curtailment signals, energy availability, or other data received from utility providers, distributed energy generation systems 424, from energy storage 427 (e.g., hot TES 242, cold TES 244, etc.), or from other sources. Demand response layer 414 may receive inputs from other layers of BMS controller 366 (e.g., building subsystem integration layer 420, integrated control layer 418, etc.). The inputs received from other layers can include environmental or sensor inputs such as temperature, carbon dioxide levels, relative humidity levels, air quality sensor outputs, occupancy sensor outputs, room schedules, and the like. The inputs may also include inputs such as electrical use (e.g., expressed in kWh), thermal load measurements, pricing information, projected pricing, smoothed pricing, curtailment signals from utilities, and the like.

According to some embodiments, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 may also include control logic configured to determine when to utilize stored energy. For example, demand response layer 414 may determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models can include, for example, thermodynamic models describing the inputs, outputs, and/or functions performed by various sets of building equipment. Equipment models may represent collections of building equipment (e.g., subplants, chiller arrays, etc.) or individual devices (e.g., individual chillers, heaters, pumps, etc.).

Demand response layer 414 may further include or draw upon one or more demand response policy definitions (e.g., databases, XML, files, etc.). The policy definitions can be edited or adjusted by a user (e.g., via a graphical user interface) so that the control actions initiated in response to demand inputs can be tailored for the user's application, desired comfort level, particular building equipment, or based on other concerns. For example, the demand response policy definitions can specify which equipment can be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 can be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated supersystem. In some embodiments, integrated control layer 418 includes control logic that uses inputs and outputs from a plurality of building subsystems to provide greater comfort and energy savings relative to the comfort and energy savings that separate subsystems could provide alone. For example, integrated control layer 418 can be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 can be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 can be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 can be configured to provide feedback to demand response layer 414 so that demand response layer 414 checks that constraints (e.g., temperature, lighting levels, etc.) are properly maintained even while demanded load shedding is in progress. The constraints may also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 can be configured to provide calculated inputs (e.g., aggregations) to these higher levels based on outputs from more than one building subsystem.

Automated measurement and validation (AM&V) layer 412 can be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 can be based on building system energy models and/or equipment models for individual BMS devices or subsystems. For example, AM&V layer 412 may compare a model-predicted output with an actual output from building subsystems 428 to determine an accuracy of the model.

Fault detection and diagnostics (FDD) layer 416 can be configured to provide on-going fault detection for building subsystems 428, building subsystem devices (i.e., building equipment), and control algorithms used by demand response layer 414 and integrated control layer 418. FDD layer 416 may receive data inputs from integrated control layer 418, directly from one or more building subsystems or devices, or from another data source. FDD layer 416 may automatically diagnose and respond to detected faults. The responses to detected or diagnosed faults can include providing an alert message to a user, a maintenance scheduling system, or a control algorithm configured to attempt to repair the fault or to work-around the fault.

FDD layer 416 can be configured to output a specific identification of the faulty component or cause of the fault (e.g., loose damper linkage) using detailed subsystem inputs available at building subsystem integration layer 420. In other exemplary embodiments, FDD layer 416 is configured to provide “fault” events to integrated control layer 418 which executes control strategies and policies in response to the received fault events. According to some embodiments, FDD layer 416 (or a policy executed by an integrated control engine or business rules engine) may shut-down systems or direct control activities around faulty devices or systems to reduce energy waste, extend equipment life, or assure proper control response.

FDD layer 416 can be configured to store or access a variety of different system data stores (or data points for live data). FDD layer 416 may use some content of the data stores to identify faults at the equipment level (e.g., specific chiller, specific AHU, specific terminal unit, etc.) and other content to identify faults at component or subsystem levels. For example, building subsystems 428 may generate temporal (i.e., time-series) data indicating the performance of BMS 400 and the various components thereof. The data generated by building subsystems 428 can include measured or calculated values that exhibit statistical characteristics and provide information about how the corresponding system or process (e.g., a temperature control process, a flow control process, etc.) is performing in terms of error from its setpoint. These processes can be examined by FDD layer 416 to expose when the system begins to degrade in performance and alert a user to repair the fault before it becomes more severe.

Referring now to FIG. 5, a block diagram of another building management system (BMS) 500 is shown, according to some embodiments. BMS 500 can be used to monitor and control the devices of HVAC system 100, waterside system 200, airside system 300, building subsystems 428, as well as other types of BMS devices (e.g., lighting equipment, security equipment, etc.) and/or HVAC equipment.

BMS 500 provides a system architecture that facilitates automatic equipment discovery and equipment model distribution. Equipment discovery can occur on multiple levels of BMS 500 across multiple different communications busses (e.g., a system bus 554, zone buses 556-560 and 564, sensor/actuator bus 566, etc.) and across multiple different communications protocols. In some embodiments, equipment discovery is accomplished using active node tables, which provide status information for devices connected to each communications bus. For example, each communications bus can be monitored for new devices by monitoring the corresponding active node table for new nodes. When a new device is detected, BMS 500 can begin interacting with the new device (e.g., sending control signals, using data from the device) without user interaction.

Some devices in BMS 500 present themselves to the network using equipment models. An equipment model defines equipment object attributes, view definitions, schedules, trends, and the associated BACnet value objects (e.g., analog value, binary value, multistate value, etc.) that are used for integration with other systems. Some devices in BMS 500 store their own equipment models. Other devices in BMS 500 have equipment models stored externally (e.g., within other devices). For example, a zone coordinator 508 can store the equipment model for a bypass damper 528. In some embodiments, zone coordinator 508 automatically creates the equipment model for bypass damper 528 or other devices on zone bus 558. Other zone coordinators can also create equipment models for devices connected to their zone busses. The equipment model for a device can be created automatically based on the types of data points exposed by the device on the zone bus, device type, and/or other device attributes. Several examples of automatic equipment discovery and equipment model distribution are discussed in greater detail below.

Still referring to FIG. 5, BMS 500 is shown to include a system manager 502; several zone coordinators 506, 508, 510 and 518; and several zone controllers 524, 530, 532, 536, 548, and 550. System manager 502 can monitor data points in BMS 500 and report monitored variables to various monitoring and/or control applications. System manager 502 can communicate with client devices 504 (e.g., user devices, desktop computers, laptop computers, mobile devices, etc.) via a data communications link 574 (e.g., BACnet IP, Ethernet, wired or wireless communications, etc.). System manager 502 can provide a user interface to client devices 504 via data communications link 574. The user interface may allow users to monitor and/or control BMS 500 via client devices 504.

In some embodiments, system manager 502 is connected with zone coordinators 506-510 and 518 via a system bus 554. System manager 502 can be configured to communicate with zone coordinators 506-510 and 518 via system bus 554 using a master-slave token passing (MSTP) protocol or any other communications protocol. System bus 554 can also connect system manager 502 with other devices such as a constant volume (CV) rooftop unit (RTU) 512, an input/output module (TOM) 514, a thermostat controller 516 (e.g., a TEC5000 series thermostat controller), and a network automation engine (NAE) or third-party controller 520. RTU 512 can be configured to communicate directly with system manager 502 and can be connected directly to system bus 554. Other RTUs can communicate with system manager 502 via an intermediate device. For example, a wired input 562 can connect a third-party RTU 542 to thermostat controller 516, which connects to system bus 554.

System manager 502 can provide a user interface for any device containing an equipment model. Devices such as zone coordinators 506-510 and 518 and thermostat controller 516 can provide their equipment models to system manager 502 via system bus 554. In some embodiments, system manager 502 automatically creates equipment models for connected devices that do not contain an equipment model (e.g., TOM 514, third party controller 520, etc.). For example, system manager 502 can create an equipment model for any device that responds to a device tree request. The equipment models created by system manager 502 can be stored within system manager 502. System manager 502 can then provide a user interface for devices that do not contain their own equipment models using the equipment models created by system manager 502. In some embodiments, system manager 502 stores a view definition for each type of equipment connected via system bus 554 and uses the stored view definition to generate a user interface for the equipment.

Each zone coordinator 506-510 and 518 can be connected with one or more of zone controllers 524, 530-532, 536, and 548-550 via zone buses 556, 558, 560, and 564. Zone coordinators 506-510 and 518 can communicate with zone controllers 524, 530-532, 536, and 548-550 via zone busses 556-560 and 564 using a MSTP protocol or any other communications protocol. Zone busses 556-560 and 564 can also connect zone coordinators 506-510 and 518 with other types of devices such as variable air volume (VAV) RTUs 522 and 540, changeover bypass (COBP) RTUs 526 and 552, bypass dampers 528 and 546, and PEAK controllers 534 and 544.

Zone coordinators 506-510 and 518 can be configured to monitor and command various zoning systems. In some embodiments, each zone coordinator 506-510 and 518 monitors and commands a separate zoning system and is connected to the zoning system via a separate zone bus. For example, zone coordinator 506 can be connected to VAV RTU 522 and zone controller 524 via zone bus 556. Zone coordinator 508 can be connected to COBP RTU 526, bypass damper 528, COBP zone controller 530, and VAV zone controller 532 via zone bus 558. Zone coordinator 510 can be connected to PEAK controller 534 and VAV zone controller 536 via zone bus 560. Zone coordinator 518 can be connected to PEAK controller 544, bypass damper 546, COBP zone controller 548, and VAV zone controller 550 via zone bus 564.

A single model of zone coordinator 506-510 and 518 can be configured to handle multiple different types of zoning systems (e.g., a VAV zoning system, a COBP zoning system, etc.). Each zoning system can include a RTU, one or more zone controllers, and/or a bypass damper. For example, zone coordinators 506 and 510 are shown as Verasys VAV engines (VVEs) connected to VAV RTUs 522 and 540, respectively. Zone coordinator 506 is connected directly to VAV RTU 522 via zone bus 556, whereas zone coordinator 510 is connected to a third-party VAV RTU 540 via a wired input 568 provided to PEAK controller 534. Zone coordinators 508 and 518 are shown as Verasys COBP engines (VCEs) connected to COBP RTUs 526 and 552, respectively. Zone coordinator 508 is connected directly to COBP RTU 526 via zone bus 558, whereas zone coordinator 518 is connected to a third-party COBP RTU 552 via a wired input 570 provided to PEAK controller 544.

Zone controllers 524, 530-532, 536, and 548-550 can communicate with individual BMS devices (e.g., sensors, actuators, etc.) via sensor/actuator (SA) busses. For example, VAV zone controller 536 is shown connected to networked sensors 538 via SA bus 566. Zone controller 536 can communicate with networked sensors 538 using a MSTP protocol or any other communications protocol. Although only one SA bus 566 is shown in FIG. 5, it should be understood that each zone controller 524, 530-532, 536, and 548-550 can be connected to a different SA bus. Each SA bus can connect a zone controller with various sensors (e.g., temperature sensors, humidity sensors, pressure sensors, light sensors, occupancy sensors, etc.), actuators (e.g., damper actuators, valve actuators, etc.) and/or other types of controllable equipment (e.g., chillers, heaters, fans, pumps, etc.).

Each zone controller 524, 530-532, 536, and 548-550 can be configured to monitor and control a different building zone. Zone controllers 524, 530-532, 536, and 548-550 can use the inputs and outputs provided via their SA busses to monitor and control various building zones. For example, a zone controller 536 can use a temperature input received from networked sensors 538 via SA bus 566 (e.g., a measured temperature of a building zone) as feedback in a temperature control algorithm. Zone controllers 524, 530-532, 536, and 548-550 can use various types of control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control a variable state or condition (e.g., temperature, humidity, airflow, lighting, etc.) in or around building 10.

### Virtualized Field Controllers and Semiconductor Farm

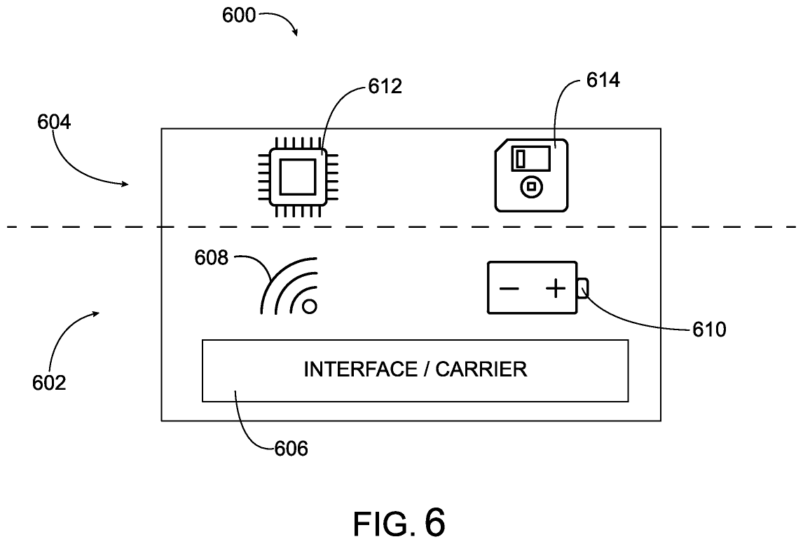

Referring now to FIG. 6, a diagram of a field controller 600 is shown, according to some embodiments. The field controller 600 is shown as including an input/output hardware unit (communications interface portion) 602 and a virtualized control portion 604. The input/output hardware unit 602 is shown as including an interface/carrier 606, a network interface 608, and power management circuitry 610. The virtualized control portion 604 is shown as including processing component 612 and memory 614. The field controller 600 can be distributed, for example with the virtualized control portion 604 decoupled from the input/output hardware unit 602.

The input/output hardware unit 602 is shown as including the interface/carrier 606, which can include a housing, board, member, etc. for carrying circuitry and/or other components of the input/output hardware unit 602. The interface/carrier 606 can include pins, ports, etc. configured to enable conductive connection (e.g., via wires, cables, etc.) of the input/output hardware unit 602 to sensors, actuators, equipment, motors, etc. located at a building and/or to a communications network (e.g., OT network, IT network, internet, intranet, etc.). The network interface 608 and the power management circuitry 610 are coupled to (e.g., mounted on) the interface/carrier 606. A field controller 600 can include one input/output hardware unit 602 or multiple input/output hardware units 602 in various embodiments, in a centralized or distributed arrangement.

The network interface 608 can include various circuitry configured (e.g., programmed) to enable network communications between the virtualized control portion 604 and the input/output hardware unit 602, including from the virtualized control portion 604 and one or more sensors, actuators, equipment units, etc. associated with the input/output hardware unit 602. Communications can be wired and/or wireless (e.g., IEEE 802.11, LoRA protocol). In some embodiments, the network interface 608 includes a wireless communications receiver/transmitter, for example circuitry enabling WiFi communications (e.g., 902.11ah HaLow), mobile telecommunications technology communications (e.g., 4G, 5G, LTE), Bluetooth® communications, Zigbee® communications, Matter communications, near-field communications, Sub-1 gigahertz communications, Li-Fi communications, and/or other types of communications. In some embodiments, the network interface 608 includes memory and processing components configured to receive, buffer, route, transmit, and otherwise handle messages (data, information, control signals, etc.) direct to and through the input/output hardware unit 602.

In network interface 608 can include multiple hardware components enabling multiple different communications modalities for communicating information on and/or off of the input/output hardware unit 602. For example, the network interface 608 can be configured to communicate both wireless (e.g., WiFi, 5G or other cellular connection, etc. as described above) and wired (e.g., Ethernet, BACNet, ModBus) in a redundant manner. Accordingly, the network interface 608 can provide for a redundant, alternative communication channel to and from the input/output hardware unit 602 to the virtualized control portion 604.

The power management circuitry 610 is configured to supply power to the network interface 608. In some embodiments, the power management circuitry 610 includes a plug, pins, wiring, etc. enabling connection of the input/output hardware unit 602 to electrical wiring of a building. In some embodiments, the power management circuitry 610 includes a battery, for example a battery used as a back-up in case of loss of external electricity to the input/output hardware unit 602. The power management circuitry 610 includes power over Ethernet (PoE) and/or a wireless power receiver and/or transmitter in some embodiments.

The virtualized control portion 604 includes the processing component 612 and the memory 614. The virtualized control portion 604 is virtualized, such that the processing component 612 and the memory 614 are provided in a virtual, digital, software-based manner, for example hosted on a semiconductor farm, server farm, data center, cloud resource, etc. as described in further detail below. The processing component 612 is configured to execute control logic for equipment associated with the controller 600, for example equipment located proximate the input/output hardware unit 602 and based, in some embodiments, on sensor data collected via the input/output hardware unit 602. The processing component 612 can execute a feedback control process, a model predictive control process, a self-optimizing control process, etc. in various embodiments. The processing component 612 may provide such operations by executing programming stored in the memory 614. Memory 614 may also store such programming instructions, data collected via the input/output hardware unit 602, and various other information, programming, data, etc. that may support the various functions described herein in various embodiments.

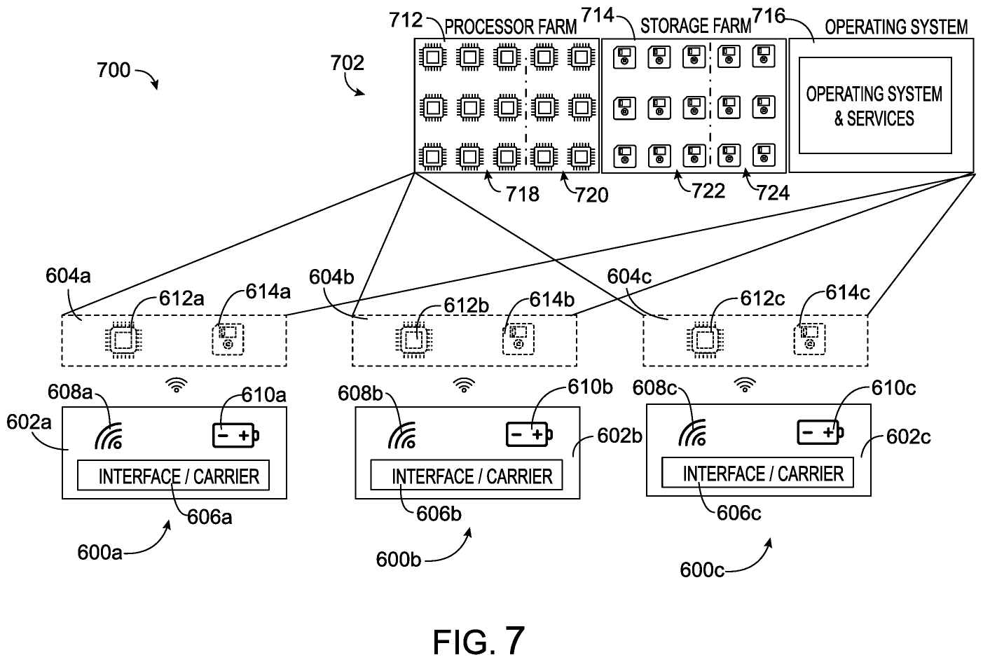

Referring now to FIG. 7, a block diagram of a system 700 including multiple field controllers 600a, 600b, 600c is shown, according to some embodiments. FIG. 7 also shows a semiconductor farm 702, which includes a processor farm 712, storage farm 714, and operating system 716. FIG. 7 illustrates that each field controller 600a, 600b, 600c includes a input/output hardware unit (602a, 602b, 602c, respectively) including the interface/carrier (606a, 606b, 606c, respectively), network interface (608a, 608b, 608c, respectively), and power management circuitry (610a, 610b, 610c, respectively). Each field controller 600a, 600b, 600c is also shown as including a virtualized control portion (604a, 604b, 604c, respectively) including a processing component (612a, 612b, 612c, respectively) and memory (614a, 614b, 614c, respectively). The virtualized control portions are physically implemented in semiconductor farm 702, in particular with the processing components 612a, 612b, 612c implemented in the processor farm 712 and the memory 614a, 614b, 614c implemented in the storage farm 714. Three field controllers are shown, while other embodiments including any number of field controllers.

The processor farm 712 includes processing circuitry (semiconductor chips, etc.) configured to provide control functions as performed by the field controllers herein (e.g., feedback control, predictive control, setpoint management, etc.). In some embodiments, each processing component (e.g., 612a) has corresponding dedicated hardware (e.g., semiconductor chips) of the processor farm 712. The storage farm 714 includes non-transitory computer-readable media configured to store programming instructions, data, etc. which enable the processor farm 712 to execute operations to provide various control and other functionalities as described herein. The operating system 616 provides an operating system for the processor farm 712 and storage farm 714 which enables setup, configuration, operation, management, etc. of the semiconductor farm 702. The semiconductor farm 702 can be remote from a building served by the field controllers, located on-premises, or some combination thereof.

The processor farm 712 and the storage farm 714 are configured to be dynamically scalable, such that additional processing power (e.g., additional processors, additional semiconductor chips, etc.) can be dynamically assigned to provide the processing component (e.g., 612a) of a virtualized component (e.g., 604a) of a field controller (e.g., 600a) depending upon the processing demands of that particular field controller (and changes in such demands). Similarly, assigned processing power of the processor farm 712 can be reduced for a field controller if demand is reduced. Resources of the storage farm 714 can be similarly assigned in a dynamic or easily adjustable manner, including by shifting data from rapid-access memory to slower-access memory or between other memory tiers depending on need and resource availability.

Such an approach enables the computing resources (processing power, memory capacity, etc.) of each field controller (e.g., 600a, 600b, 600c) to by dynamically updated over time without physically need to install new devices, extra hardware, etc. in the field (e.g., in a building), i.e., without modifying the input/output hardware units 602a, 602b, 602c. As a result, less physical intervention in a building is required, less manufacturing of devices is needed, shipping of devices (and associated supply chain challenges, transportation-related emissions, etc.) is reduced, and other associated advantages are captured.

As shown in FIG. 7, the processor farm can include multiple different types of processing chips, shown as first chips 718 of a first type and second chips 720 of a second type in FIG. 7. Chips 718 and 720 can be integrated circuit devices included in packages. The packages can include on or more of chips 718 and 720. In some embodiments, first chips 718 and second chip 720 can each be a combination of two or more chips. Additional different types of chips can be included in various embodiments. In some embodiments, the first chips 718 and/or the second chips 720 are configured to be particularly adapted to different applications, algorithms, types of programming, etc. such that the processor farm includes different types of chips that can be selectively deployed to best provide different applications, algorithms, etc. as part of controller virtualization as described herein.

In some embodiments, the first chips 718 are configured to execute rules-based control logic and other processing tasks, while the second chips 720 are specialized artificial intelligence chips particularly adapted for use in executing artificial intelligence (AI) algorithms (e.g., deep learning models, large language models, neural networks, generative artificial intelligence modules). For example, the second chips 720 may be configured to execute more simultaneous calculations as compared to the first chips 718 while calculating numbers with lower precision (as compared to the first chips 718) in a manner sufficient for AI algorithms while limiting the number of transistors needed for such multiple calculations, by adapting memory access for requirements of AI algorithms, and otherwise being adapted to executing the programming of AI algorithms faster and more efficiently as compared to other chip designs. The AI-adapted second chips 720 may be more resource intensive to produce, may be in relatively scarce supply, etc. as compared to the first chips 718, which may be relatively low-cost, available, less resource intensive, etc., but the can be capable of executing certain features (e.g., AI algorithms) for a virtualized controller which the first chips 718 may not be able to complete sufficiently quickly for the online control of building equipment as described herein (or may complete with other limitations, difficulty, cost, etc.).

In such embodiments, the virtualized controllers described herein can be selectively provided with artificial intelligence capabilities by the semiconductor farm by allocating use of one or more of the second chips 720 virtual controllers for which an AI tool (algorithm, model, control logic, etc.) is enabled (e.g., requested by a building operator) while other virtual controllers (for which AI features are not desired) can be executed using one or more of the first chips 718 without consuming resources of the second chips 720. For example, a first virtual controller (e.g., for a complex unit of equipment such as a chiller, for a virtualized supervisory controller, for a high priority space, for a high occupancy space, etc.) can be provided with AI functionality by the semiconductor farm providing use of AI-adapted second chips 720 for the first virtual controller while a second virtual controller (e.g., for a relatively-simple device or unit of equipment such as a fan, for a low priority space, for a low occupancy space) can be virtualized using the less-expensive, more-available, more-efficient first chips 718. AI techniques such a regenerative AI can be utilized. The processor farm 712 can adaptatively and dynamically adjust allocation of the first chips 718 and the second chips 720 to different virtual controllers over time as different features are enabled or disabled for different virtual controllers or corresponding equipment. In some embodiments, different features of an individual virtual controllers are provided by different types of chips in the processor farm 712. Furthermore, new chips adapted for new control and monitoring features for virtual controls that may be developed can be added to the processor farm 712 and used to execute such features, without requiring installation of new field controllers or other edge devices. The teachings herein thereby enable dynamic selection and assignment of appropriate computing hardware to different tasks as appropriate for best providing the virtual controllers described herein, for example so that artificial intelligence functions (e.g., fault detection or prediction, root cause analysis, active setpoint management, predictive control, occupancy prediction, modeling of building conditions, AI-driven feedforward control, etc.)(e.g., generative AI features, generative-AI-driven self-optimization and/or other features as in U.S. Provisional Patent Application No. 63/470,831 filed Jun. 2, 2023, the entire disclosure of which is incorporated by reference) can be selectively enabled for certain virtual controllers and executed on appropriate types of processing hardware where other programs (e.g., feedback control) can be selectively enabled executed on different processing hardware.

As also shown in FIG. 7, the storage farm 714 can include first memory devices 722 of a first type and second memory devices 724 of a second type, for example different types of memory devices which have different capabilities, strengths, weaknesses, etc. and thus may be better suited for different types of control programs, artificial intelligence algorithms, etc. that may be desired for execution by the virtual controllers herein, for example different memory bandwidth or the like. The first memory devices 722 and the second memory devices 724 can be sorted according to such properties to appropriate virtual controllers to best support the different functions that can be dynamically selected for execution by different virtual controllers. For example, the first memory devices 722 may provide faster access to data stored as compared to the second memory devices 724 but may be more resource intensive to manufacture, maintain, or support, and thus may be used for particular virtual controllers or operations benefiting from such access, whereas the second memory devices 724 may be used for other virtual controllers or operations. For example, the first memory devices 722 may provide higher memory bandwidth and can be allocated to virtual controllers providing functions with higher memory requirements (e.g., higher sample rates, numerous associated points, functions driven by large data sets, artificial intelligence techniques, etc.) while the second memory devices 724 may provide lower memory bandwidth and can be allocated to virtual controllers providing functions with lower memory requirements (e.g., lower sample rates, one associated point, rules-based function driven by current point value, etc.), such that the types of memory devices are allocated across virtual controllers based on memory bandwidth requirements of the different virtual controllers.

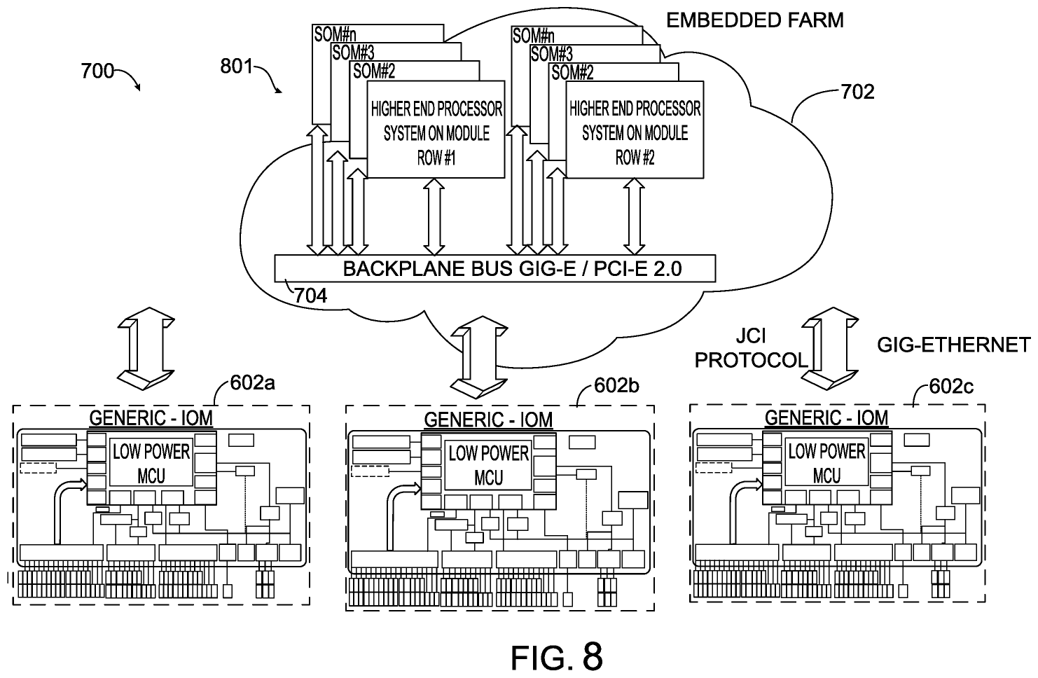

Referring now to FIG. 8, another diagram of the system 700 is shown, according to some embodiments. FIG. 7 shows the input/output hardware units 602a, 602b, and 602c in communication with the semiconductor farm 702. As shown, the input/output hardware units 602a, 602b, and 602c can be generic, i.e., similar to or the same as one another, even if serving different types of equipment, handling different types of sensors, etc. The input/output hardware units 602a, 602b, and 602c can each include a low power micro-controller, small flash memory (e.g., 1 MB) and RAM (e.g., 512 KB), various ports (e.g., USB, Ethernet) and pins, and power supply and management circuitry.

The semiconductor farm 702 is shown as including a backplane bus 704 and multiple processor modules 801 (high end processor). The multiple processor modules 801 are communicable with the backplane bus 704 to obtain data from the backplane bus 704 and provide data to the backplane bus 704. In some embodiments, each processor module 801 corresponds to one input/output hardware unit (e.g., 602a, 602b, or 602c). In some embodiments, each row of processor modules 801 corresponds to one input/output hardware unit (e.g., 602a, 602b, or 602c). Various arrangements are possible. FIG. 8 thereby illustrates a schematic architecture that can be used, in some embodiments.

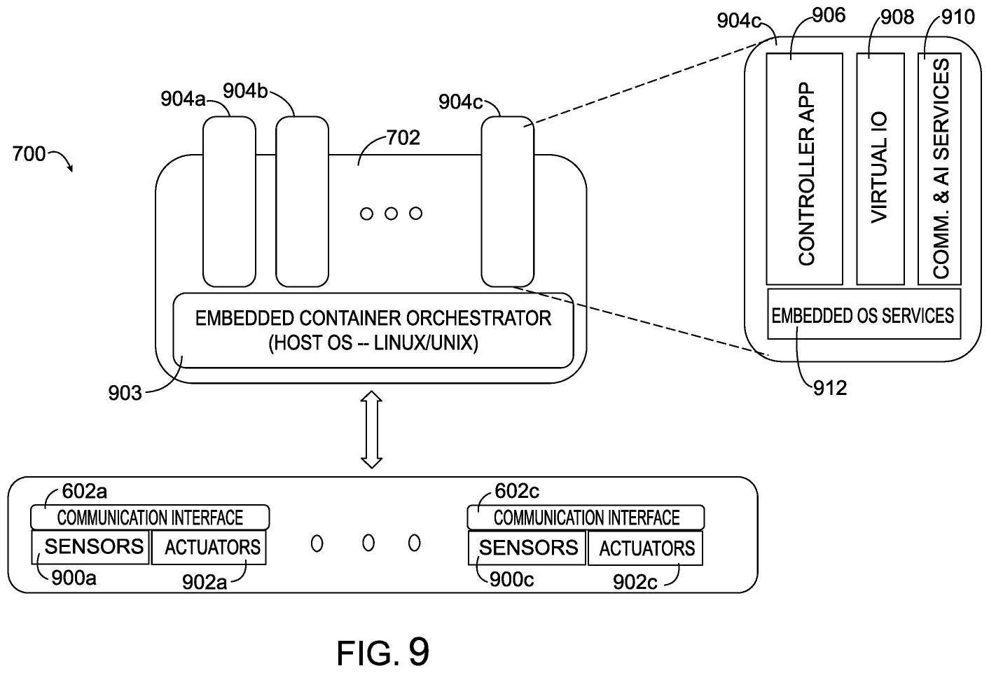

Referring now to FIG. 9, another schematic diagram of the system 700 is shown, according to some embodiments. As shown in FIG. 9, the system 700 includes the semiconductor farm 702 and multiple input/output hardware units (shown as communication interfaces) 602a through 602c. The input/output hardware units 602a through 602c are provided with sensors (900a, 900c, respectively) and actuators (902a, 902c, respectively), such that each input/output hardware unit is associated with and provides communications for one or more sensors and/or one or more actuators. The actuators 902a, 902c can include linear or rotational actuators (e.g., for opening valves and dampers), motors (e.g., fan motors), and other electromechanical equipment (e.g., compressors, refrigeration cycles, heating coils, resistive heaters, lighting devices, etc. The sensors 900a can include any type of sensor or meter (e.g., temperature sensors, humidity sensors, pressure sensors, airflow sensors, brightness sensors, cameras, CO₂ sensors, air quality sensors, electricity meters, natural gas meters, etc.).

In FIG. 9, the semiconductor farm 702 is shown as including an embedded container orchestrator 903 and multiple containers (shown as containers 904a, 904b, 904c). The embedded container orchestrator 903 can run a host operating system, for example a Linux/Unix operating system. Each of multiple containers 904a, 904b, 904c can be consider as being an instance of the virtualized control portion 604a, 604b, 604c (e.g., as shown in FIG. 7) of a field controller. That is, the virtualized control portion 604 of the field controller 600 can be provided as a container (e.g., 904a) in the semiconductor farm 702. The containerized approach can allow for addition of any number of containers to correspond to any number of field controller 600, thereby providing an easily scalable approach. Containerization herein can be implemented using the teachings of Indian Application No. 202341008712 filed Feb. 10, 2023; Indian Application No. 202221058521, filed Oct. 13, 2022; or Indian Application No. 202341040167, filed Jun. 13, 2023, the entire disclosures of which are incorporated by reference herein.

As shown in FIG. 9, a container (e.g., container 904c as shown) can include a controller application 906, a virtual input/output 908, communication and AI services 910, and embedded OS services 912 (providing a real time operating system (RTOS) and various other services required for running of the various components of the container 904c). The controller application 906 can execute various control logic in various embodiments to control one or more actuators (e.g., 902a, 902c), for example based on data from one or more sensors (e.g., 900a, 900c). The virtual input/output 908 can facilitate input and output of data and control signals from the controller application 906. The communications and AI services 910 can provide various communication services (e.g., communications protocol management, routing and transmittal of communications, etc.), including for communications with a corresponding input/output hardware unit 602c and for communications between virtual controllers (e.g., between containers 904a,b,c).

The communications and AI services 910 can also provide the virtual controller (e.g., container 904c) to run one or more artificial intelligence (AI) algorithms associated with the corresponding controller. For example, the communications and AI services 910 can includes an AI model (e.g., neural network model, deep learning model, reinforcement learning model, etc.) for the corresponding controller, for example to perform operations associated with control of equipment (e.g., AI-model-driven optimization of equipment settings, setpoints, on/off decisions, etc.), fault prediction or diagnosis, generation of controller test data or other simulation data, or other AI features associated with particular equipment, sensors, points, spaces, etc. associated with a virtual controller. In some embodiments, the AI model is configured to operate on streaming input data, for example to recognize or other patterns without backtracking (e.g., without storing data), thereby enabling the AI model to avoid adding to buffering and cache tasks of the architecture described herein. As described above, the communications and AI services 910 can be allocated a different type of chip (processing resource, etc.) in the semiconductor 702 as compared to other containers without such AI services and/or as compared to the controller application 906, in various embodiments. Virtualization of such AI services enables processing resources, including specialized hardware adapted to AI applications, to be dynamically assigned based on the features to be executed by different containers 904a,b,c. (e.g., dynamically assigned by the embedded container orchestrator 903). The system 700 can thereby provide various artificial intelligence services (e.g., auto-configuration, fault detection and prediction, trend analysis, active setpoint management, etc.).

Each field controller can have a dedicated container provided by the semiconductor farm 702 such that dedicated control logic and other services are provided for each field controller, in some embodiments. In other embodiments, a container may serve multiple field controllers (i.e., multiple input/output hardware devices). In some embodiments, the containerized approach can include provisioning for third-party software development kits.

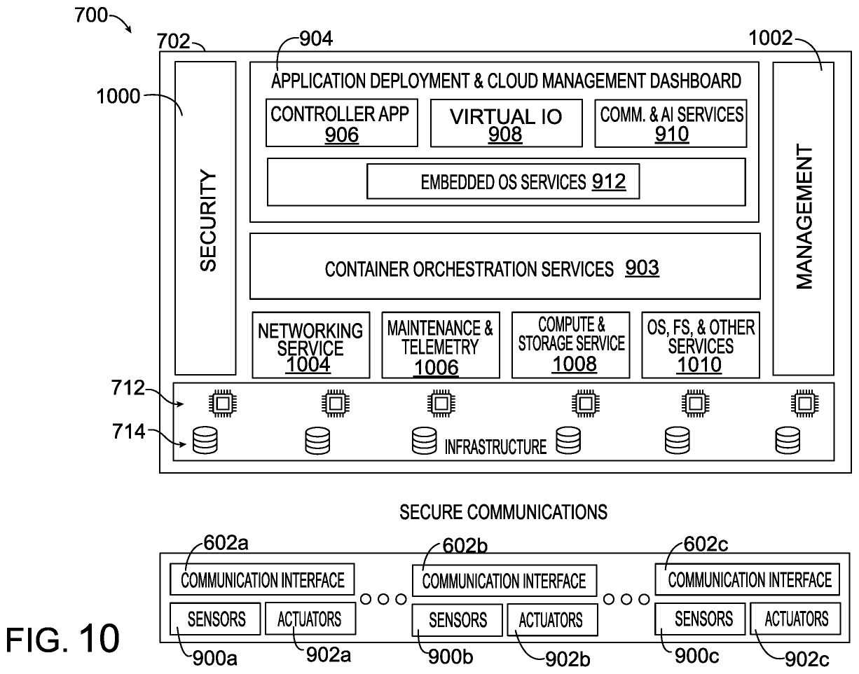

Referring now to FIG. 10, another diagram of the system 700 is shown, according to some embodiments. In the example of FIG. 10, the system 700 includes various components described above. FIG. 10 shows semiconductor farm 702 as including a container 904 having the controller application 905, virtual input/output 908, communication and AI services 910, and embedded OS services 912, along with container orchestration services (embedded container orchestrator) 903 running on infrastructure including the processor farm 712 and the storage farm 714. FIG. 10 shows that the security service 1000, management service 1002, networking service 1004, maintenance and telemetry service 1006, compute and storage service 1008, and OS, FS, and other services 1010 can also be provided on the semiconductor farm 702 (e.g., run on the processor farm 712 and the storage farm 714). FIG. 10 shows a modular and scalable embedded farm architecture that can be hosted on cloud, on-premises, or hybrid in various embodiments.

The security service 1000 is configured to provide secure communications, access control, and/or other cybersecurity features to prevent or reduce the risk of unauthorized access or other cyberattack on the system 700. The security service 1000 can use firewall technologies, zero-trust features, host identity protocol communications, authentication technologies, secure remote access features, etc. to provide comprehensive security measures. For example, in some embodiments, the semiconductor farm 702 communicates with the input/output hardware units 602a-c via an overlay network, airwall architecture, etc., for example as described in U.S. Pat. No. 10,038,725 granted Jul. 31, 2018, U.S. Pat. No. 10,178,133 granted Jan. 8, 2019, U.S. Pat. No. 9,621,514 granted Apr. 11, 2017, U.S. Pat. No. 10,797,993 granted Oct. 6, 2020, U.S. Pat. No. 10,911,418 granted Feb. 2, 2021, or U.S. Pat. No. 10,999,154 granted May 4, 2021, the entire disclosures of which are incorporated by reference herein in their entireties.

In some embodiments, multiple secure communications channels are provided between the input/output devices 602 and the semiconductor farm 702, for example via different communications modalities. For example, the semiconductor farm 702 may primarily rely on communicating with the input/output devices 602 via building information technology network (e.g., Ethernet, WiFi) and/or industrial device network (e.g., ModBus, BACnet) when such networks are online and available, for example via the Internet in scenarios where the semiconductor farm 702 is located remotely from the building site. In this example, the input/output devices 602 may also include capability to communicate via cellular network or other independent channel such that a redundant communication channel is provided between the input/output devices 602 and the semiconductor farm 702 to reduce the risk that communication is lost between the input/output devices 602 and the semiconductor farm 702. In such embodiments, if communications are interrupted, disconnected, etc. via a first communication modality, the second (e.g., back-up) communications modality can be used to provide secure communications between the input/output devices 602 and the semiconductor farm 702. In some embodiments, the security service 1000 is configured to manage such multiple communications channels to facilitate substantially-uninterrupted secure communications between the semiconductor farm 702 and the input/output devices 602. The primary communication channel and/or the secondary communication channel can use a communication protocol adapted to ensure that communications are delivered in a time-sensitive manner (e.g., in less than a threshold amount of time, etc.) thereby facilitating active control by the semiconductor farm 702 of edge equipment.

The management service 1002 is configured to provide management of the semiconductor farm 702, including management of communications to and from the semiconductor farm 702. For example, the management service 1002 may provide of reducing communication delay in the system 700 by providing balanced transmission and/or through use of cloud cache to avoid latency that may otherwise occur from the moving of data. The system 700 may also use prevalent protocols to help minimize latency. Such features can be provided in coordination with networking service 1004, which is configured to providing networking features such as connecting to a network (e.g., internet, building IT/OT network), handling communications protocols, directing communications to appropriate addresses, etc. The management service 1002 is configured to provide for registering and deregistering of equipment controllers and can provide containers for running testing and debugging instances (e.g., simulated virtual controllers), for example by providing a digital twin of a building site for use in testing virtual controllers in simulation using the digital twin. In some embodiments, the management service 1002 is configured to form clusters of virtual controllers with similar properties (e.g., similar operations, similar purposes, similar associated data, etc.) and analyze similarities therebetween to generate improved (e.g., optimized) control strategies for such controllers. In some embodiments, the management service 1002 is configured to host a graphical user interface configured to allow a user to view and/or manipulate various information relating to the system 700, for example relating to the allocation of processing and memory resources to the various virtual controllers (e.g., identifying the hardware allocated to each virtual controller, etc.). In some embodiments, the management service 1002 is configured to cause reallocation of resources of the semiconductor farm 702 across virtual controllers responsive to a command, request, setting, selection, constraint, etc. input by a user.

The maintenance and telemetry service 1006 may be configured to provide features relating to maintaining efficient operations of the semiconductor farm 702 and recording data indicative of demand on the semiconductor farm 702 (e.g., processor usage, memory usage, etc.). Such telemetry data can be used to dynamically scale processing and storage allocations to different containers (e.g., to different field controllers). For example, the compute and storage service 1008 may be configured to dynamically reassign resources of the semiconductor farm 702 based on maintenance and telemetry information from the maintenance and telemetry service 1006. In some embodiments, the maintenance and telemetry service 1006 are configured to associate processing and storage allocations with data relating to building conditions, occupancy, weather, seasons (e.g., time of year), building schedules, type of building space, etc. to facilitate dynamic reassignment of resources based on factors additional to monitored computing and memory resource usage. For example, the compute and storage service 1008 can be configured to dynamically reassign resources of the semiconductor farm 702 from a virtual controller associated with an unoccupied space to a virtual controller associated with an occupied space based on data collected by the maintenance and telemetry service 1006. As another example, the maintenance and telemetry service 1006 can determine that certain virtual controllers have little or no usage on a seasonal basis or based on weather data (e.g., controllers of a heating system may go unused in summer or above certain outdoor air temperatures; chiller controllers may go unused in winter or below certain temperatures), such that seasonal and/or weather information can be used by the maintenance and telemetry service 1006 as part of monitoring and assessing usage of computing infrastructure (processors 712, memory 714) and facilitate reallocation of resources based on various combinations of such usage and other information (e.g., in a predictive manner based on climate and/or weather forecasts).

The OS, FS, and other services 1010 is configured to provide various other operating system, file system, other features providing a framework for execution of the various other functions attributed herein to the semiconductor farm 702. In some embodiments, the other services 1010 include artificial intelligence services. In some embodiments, such artificial intelligence services included supervisory control services, for example providing control decisions, targets, setpoints, etc. to be used by the individual virtual controllers, for example providing optimization of overall building objectives such as energy consumption, carbon emissions, occupant comfort, indoor air quality, or infection risk, or any combination thereof. In some embodiments, such artificial intelligence services facilitate auto-commissioning and autoconfiguration features for the system 700, for example based on data from the input output devices 602 and/or building design data (e.g., building information model, project plans for building management systems, etc.). Such artificial intelligence services can provide real time monitoring and diagnosis, for example adjusting control applications executed by the various control applications 906 of the virtual controllers to adapted building operations to improve performance, avoid faults, or otherwise adjust building operations (e.g., without human intervention). In some embodiments, the artificial intelligence services (included in other services 1010) can include dynamically changing the status or configuration of virtual controllers based on various factors, e.g., occupancy, seasonality, environmental conditions, emergency events, load demand, compliance requirements, etc. In some examples, the artificial intelligence can use internet information to determine issues related to air quality, weather, occupancy, holidays, etc. for use in controlling the HVAC system.

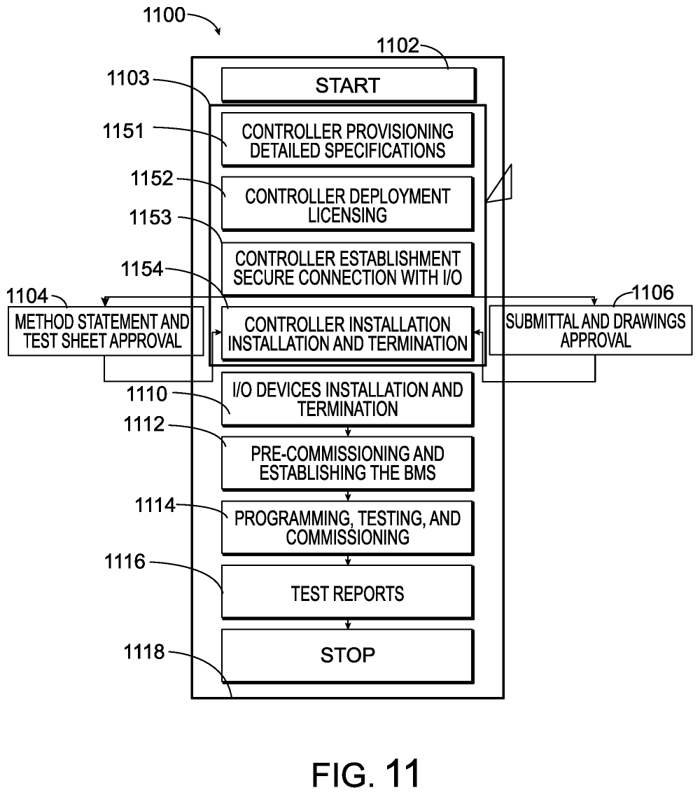

Referring now to FIG. 11, a flowchart of a process 1100 for configuring field controllers is shown, according to some embodiments. The process 1100 can be used to bring the system 700 online to serve a particular building for example.

The process is started (from step 1102) with setup of field controllers such as field controllers 600a, 600b, 600c described above in step 1103. Step 1103 includes multiple sub-tasks, including controller provisioning (sub-task 1151), controller deployment (sub-task 1152), controller establishment (sub-task 1153), and controller installation (sub-task 1154). Controller provisioning (sub-task 1151) can include creation of virtualized control portions, containers, control applications, etc. as in the examples of FIG. 6-10, for example based on detailed specifications for a building and/or BMS. Controller deployment (sub-task 1152) can include controller deployment, for example bringing virtualized control portions online in a semiconductor farm, verifying licenses, etc. Controller establishment (sub-task 1153) can include establishing secure connections between input/output hardware units 602 and virtualized control portions 604 such that field controllers are established. Controller installation (sub-task 1154) can include physically installing the input/output hardware units 602 in a building and in communication with equipment, sensors, actuators, etc. that serve the building, connecting power supplies, etc. and/or claiming space (e.g., chips, memory, processors, etc.) for each controller on a semiconductor farm.

Sub-task 1154 and, in some embodiments, other sub-tasks of step 1103 can be based on method statement and test sheet approval (step 1104) and submittal and drawings approval (step 1106). Steps 1104 and 1106 can correspond to developing a plan for a facility, including detailed ordering of equipment and devices for the building, definition of points and relationships for the building, wiring diagrams, etc. (e.g., in a system configuration tool, in a BMS project management tool, etc.), along with approval of such plans.

Such approved plans can be fed into step 1103, including sub-task 1054, where virtual controller installation and termination is performed. Installation and termination may be a one-time activity, with all commissioning, troubleshooting, etc. performed virtually. Step 1103 can include claiming space on a semiconductor farm which also serves other computing needs (e.g., provides virtualized control for other buildings). Step 1103 can include installing an on-premises semiconductor farm. Step 1103 can also including initiating containers for each field controller identified in the plans from step 1103, including in some embodiments by choosing the control logic to be executed by the control application 906 of each container based on the equipment/sensors/etc. planned to be associated with such field controller.

At step 1110, input/output hardware units are installed at a building, including physically placing the input/output hardware units in the building at suitable positions and connecting the input/output hardware units to corresponding sensors, actuators, power supplies, etc. Installing the input/output hardware units can be performed according to plans from steps 1104 and 1106.

At step 1112, a building management system is pre-commissioned and established. Step 1112 corresponds to establishing an initial version of a building management system based on data from preceding steps, such that a framework is provided which can be refined as programming, testing, and commission is performed in step 1114. Steps 1112 and 1114 can result in a fully programmed, validated, and commissioned building management system that includes field controllers with virtualized control portions provided by cultivating a semiconductor farm as described herein. In some embodiments, steps 1112 and 1114 are substantially similar to commissioning workflows provided for other controller and BMS architectures (e.g., as for Metasys® by Johnson Controls) such that technicians with established experience with conventional controllers can seamlessly understand how to program, commission, etc. the virtualized controllers described herein. In some embodiments, virtualization of controllers and use of the semiconductor farm enables automation of some or all commissioning, testing, and programming steps by providing direct access to increased computing resources which can execute artificial intelligence and other algorithms to automatically identify point mappings, optimize parameters, select control logic, etc. As a result of step 1114, test reports are output in step 1116 indicating successful (or otherwise) commissioning of the BMS. Commissioning is thus complete and can step at step 1118.

A user-friendly commissioning process that is intuitive to experienced buildings professionals can thereby be provided for the field controllers and semiconductor farm described herein. Process 1100 also provides other advantages enabled by virtualization, including allowing testing earlier in the process as compared to other architectures, allowing catching issues early to enable design adjustments. Virtual testing are also repeatable, physically easier to accomplish for technicians, and cheaper to perform than in-person testing (e.g., less labor intensive). Testing in the virtualized architecture can also facilitate brining what-if scenarios to life and analyzing system throughput to identify bottlenecks to help make better decisions. All such features can contribute to reducing the time needed from expert engineers in bringing a system online. Virtualization as described herein can also enable operator training without disrupting the current system (e.g., through simulations, etc.). Many technical advantages are thus provided by the features described herein and illustrated in the drawings.

### Configuration of Example Embodiments

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, calculation steps, processing steps, comparison steps, and decision steps.

The construction and arrangement of the systems and methods as shown in the various embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the embodiments without departing from the scope of the present disclosure.

What is claimed is:

1. A system, comprising:
a semiconductor farm programmed to provide a plurality of virtualized controllers; and
a plurality of input/output hardware units corresponding to the plurality of virtualized controller, wherein the plurality of virtualized controllers control building equipment via the plurality of input/output devices;
wherein the plurality of input/output hardware units are configured to communicate with the semiconductor farm via first communications modality and a second communications modality, wherein the input/output hardware units communicate with the semiconductor farm via the second communications modality responsive to interruption of the first communications modality.

2. The system of claim 1, wherein the semiconductor farm is programmed to provide the plurality of virtualized controllers in a plurality of scalable containers.

3. The system of claim 1, wherein the semiconductor farm is further configured to automatically adjust allocations of processing power and/or memory to the plurality of virtualized controllers based on demands of the plurality of virtualized controllers.

4. The system of claim 1, wherein the semiconductor farm comprises a first type of chip and a second type of chip, wherein the semiconductor farm is configured to provide the first virtual controller using the first type of chip and provide the second virtualized controller using the second type of chip based on different functions to be provided by the first virtualized controller and the second virtualized controller.

5. The system of claim 4, wherein the second type of chip is configured for artificial intelligence processing and wherein the second virtualized controller is configured to provide an artificial intelligence function.

6. The system of claim 5, wherein the semiconductor farm is configured to reallocate, responsive to selection of the artificial intelligence function for the first virtualized controller, one or more chips of the second type of chip to the first virtualized controller.

7. The system of claim 1, wherein the plurality input/output hardware units are configured to control the building equipment in a fail-safe routine in response to a loss of communications in both the first communications modality and the second communications modality between the plurality of input/output modules and the semiconductor farm.

8. The system of claim 1, wherein the building equipment comprises a plurality of sensors and actuators corresponding to the plurality of input/output hardware units and the plurality of virtualized controllers.

9. A method, comprising:
providing, via a semiconductor farm, a plurality of virtual controllers;
automatically allocating different types of processing hardware or memory hardware of the semiconductor farm across the plurality of virtual controllers such that different controllers of the plurality of virtual controllers are provided with different types of processing hardware or memory hardware; and
controlling, via an edge device coupled to building equipment, the building equipment using the plurality of virtual controllers.

10. The method of claim 9, comprising allocating the different types of memory hardware based on different memory bandwidth requirements of the plurality of different controllers.

11. The method of claim 9, wherein the plurality of different types of processing hardware comprise artificial-intelligence-adapted chips, the method comprising allocating the artificial-intelligence-adapted chips to a first subset of the plurality of virtual controllers and not to a second subset of the plurality of virtual controllers.

12. The method of claim 11, comprising determining the first subset as controllers of the plurality of virtual controllers for which at least one artificial intelligence function is selected.

13. The method of claim 9, further comprising:
communicating between the semiconductor farm and the edge device via a primary communications channel; and
communicating, responsive to an interruption of the primary communications, between the semiconductor farm and the edge device via a back-up communications channel.

14. The method of claim 13, wherein the primary communications channel comprises a building automation network and wherein the back-up communications channel comprises a cellular network.

15. The method of claim 13, further comprising controlling, by the edge device, the building equipment in a fail-safe routine responsive to interruption of both the primary communications channel and the back-up communications channel.

16. The method of claim 13, providing, via the semiconductor farm, the plurality of virtual controllers comprises providing a plurality of scalable containers.

17. A field controller for building equipment, comprising:
a communications interface configured to provide communications between building equipment and a semiconductor farm via a plurality of communications modalities; and
a virtualized control engine executing control logic at the semiconductor farm;
wherein the field controller is configured to control the building equipment to affect a variable state or condition of a building by executing the control logic.

18. The field controller of claim 17, wherein at least one of the plurality of communications modalities uses a host identity protocol and an overlay network.

19. The field controller of claim 17, wherein the communications interface communicates with the semiconductor farm via both a wired channel of the plurality o communications modalities and a wireless channel of the plurality of communications modalities, the wired channel independent of the wireless channel.

20. The field controller of claim 17, wherein the virtualized control engine is configured to be selectively provided using artificial-intelligence-adapted hardware of the semiconductor farm responsive to selection of an artificial intelligence feature for the virtualized control engine.
